(19) United States
(12) Patent Application Publication
(10) Pub. No.: US 2008/0028631 A1
(43) Pub. Date: Feb. 7, 2008

(54) SYSTEM FOR DRYING FUEL FEEDSTOCKS

(75) Inventor: James Francis Leahy, Tulsa, OK (US)

Correspondence Address: BUSKOP LAW GROUP, P.C., 4511 Dacoma Street, HOUSTON, TX, 77092, US

(73) Assignee: SYNTROLEUM CORPORATION, Tulsa, OK (US)

(21) Appl. No.: 11/856,397

(22) Filed: Sep. 17, 2007

Related U.S. Application Data
(63) Continuation-in-part of application No. 11/499,938, filed on Aug. 7, 2006, now Pat. No. 7,271,201.

(51) Int. Cl. F26B 3/02

(52) U.S. Cl. 34/82; 34/86

(57) ABSTRACT

A system for drying fuel feedstocks, comprising a heat exchanger to heat an initial nitrogen gas and a combustion turbine engine for producing a combustion turbine exhaust. An apparatus for forming a pulverized fuel receives the heated nitrogen gas and combustion turbine exhaust, forming a steam and nitrogen mixture with the pulverized fuel source. A filter receives the mixture for filtering the dried fuel feedstock from the steam and nitrogen. The system further comprises a blower for applying a vacuum to the filter to separate the steam and nitrogen mixture into a discharge stream for and a recycle stream for mixing with additional dry nitrogen gas prior to mixing with combustion turbine exhaust in a continuous process.

### CROSS REFERENCE TO RELATED APPLICATIONS

The patent application is a continuation-in-part application that claims the benefit, under 35 USC §120, of the co-pending non-provisional U.S. Application Ser. No. 11/499,938, which was filed Aug. 07, 2006. The prior co-pending non-provisional application is incorporated by reference along with its appendices

### FIELD

The present embodiments generally relate to a system for drying fuel feedstocks.

### BACKGROUND

Refineries and plants, such as those that perform Fischer-Tropsch reactions, can produce a large amount of heat, which is typically released into the environment as waste heat without recycling, and can contribute to thermal pollution.

Use of dry fuel feedstock achieves higher yields of hydrogen and carbon monoxide and lower yields of carbon dioxide than wet fuel feedstock in gasification processes. However, drying is a utility-intensive operation that can consume fuel worth as much as 50% of the value of the dry fuel feedstock.

A need exists to use waste heat to heat materials in other processes, such as the drying of fuel feedstocks, creating a more environmentally friendly system that substantially reduces the release of waste heat to the environment, thus protecting the environment.

A need also exists to reduce demands for natural gas by offering a low cost alternative to the use of natural gas for the production of hydrogen for fuel and other products, by enabling the use of cheaper coal stocks or biomass that can be used in gasification processes.

A need exists for a system that facilitates the use of biomass as a fuel for gasification processes to reduce new carbon dioxide emissions into the environment.

A need exists for a system that enables a low cost or environmentally friendly fuel feedstock drying method for use in gasification plants.

The present embodiments meet these needs.

### BRIEF DESCRIPTION OF THE DRAWINGS

The detailed description will be better understood in conjunction with the accompanying drawings as follows:

FIG. 1 depicts a schematic of a pulverized fuel treatment system operated in conjunction with a Fischer-Tropsch reactor.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present system beneficially reduces thermal emissions, which can contribute to global warming and other environmental degradation, by enabling use of waste heat, such as that from a Fischer-Tropsch synthesis reactor, to form a dry fuel feedstock. Heat that would otherwise be released into the atmosphere in the form of steam is thereby captured and flowed to a heat exchanger, where energy is recovered for use in the drying of fuel feedstocks. Energy and matter in the form of combustion turbine exhaust is captured for reuse in the same drying process.

Use of combustion turbine exhaust is uniquely beneficial due to the fact that the combustion turbine exhaust provides a large quantity of mass into which moisture from fuel feedstocks can evaporate. Conventional drying methods require large quantities of inert gas to dry fuel feedstocks, which the present system overcomes through use of combustion turbine exhaust together with significantly smaller quantities of nitrogen. Use of combustion turbine exhaust enables any remaining nitrogen needs to be met by an air separation unit sized to produce oxygen for gasification.

The present system further advantageously produces a dry fuel feedstock in a manner more efficient than conventional methods. Use of dry fuel feedstock, entrained in a flow gas, produces higher yields of hydrogen and carbon monoxide and lower yields of carbon dioxide than other gasification processes. Conventional drying, however, is a utility-intensive operation that can consume fuel worth as much as 50% of the value of the dry fuel feedstock and can require nitrogen gas in excess of what is typically available from an air separation plant used to produce the oxygen needed for gasification. Through use of combustion turbine exhaust, the present system can produce large quantities of hot gas for drying a fuel feedstock more efficiently than conventional means.

The present system is especially advantageous in the gasification of biomass, which can include wet agricultural wastes, such as chips, grasses, and corn waste, where avoidance of water in the feed is of special importance. Many biomass feedstocks exhibit high moisture content, and many types of biomass exhibit a low heating value due to high oxygen content. Agricultural wastes have been traditionally unusable as a fuel unless dried, which can require a long span of time in the sun, or use of electric blowers or similar equipment that obtains power from fossil fuels, making use of biomass extremely expensive and energy-inefficient. The present system can be used to dry biomass feedstocks in an energy-efficient manner, using waste heat and recycled heat.

The present system can thereby effectively produce a dry biomass feedstock, which provides a greenhouse gas neutral fuel, which advantageously does not increase a facility's accountability for new carbon dioxide emissions.

The present system provides a further benefit by providing a more energy-efficient method for creating a dry fuel feedstock. Typically, large volumes of hot gas are generated from purpose flue gas, such as incinerator effluent, which can require large quantities of air and fossil fuels. The present system uses combustion turbines to simultaneously produce both mechanical energy and heated exhaust at a temperature sufficient to produce a dry fuel feedstock.

The present system enables wet coal dust to be dried in a manner which is generally cheaper in cost than currently used means. The system enables the wet coal dust or biomass to be heated, vaporizing water, thereby forming the dry fuel feedstock.

The steam is then able to be reused to dry fuel in a cyclical, continuous process. In this manner, the yield of hydrogen and carbon monoxide from the gasification process is increased.

The present embodiments relate to a system for drying fuel feedstocks, such as coal feedstock, biomass feedstock, or combinations thereof, by removing water from the fuel.

Water is undesirable in coal gasification feedstocks as wet fuel feedstocks will not produce as high gasification temperatures and carbon monoxide yields as dry coal.

Water reduced coal, water reduced biomass, or combinations of these are desirable, even if 6 wt % to 12 wt % water remains in the coal or biomass.

The present embodiments enable the water content of fuel feedstocks to be reduced to less than 10%, and as low as about 8%, by removing at least 5% by weight and up to 35% by weight of water from the fuel feedstocks. The percent by weight of water is defined as the amount of water per unit mass of a coal feedstock quantity.

The fuel source is contemplated to be dried using a heat source, which can be a waste heat source, such as nitrogen heated by steam from a Fischer-Tropsch reaction of high molecular weight hydrocarbon mixtures and/or exhaust from a combustion turbine.

The present system includes a heat exchanger, which can include a shell and tube heat exchanger, such as one made by Cust-O-Fab of Sand Springs, Okla., a fin-fan heat exchanger, a welded plate and frame heat exchanger, such as those made by Tranter, Incorporated of Wichita Falls, Tex., or other similar heat exchangers. The heat exchanger receives an initial nitrogen gas from a nitrogen source, which can be an air separation plant or similar air separation facility, and heats the initial nitrogen gas to a temperature ranging from about 212 degrees Fahrenheit to about 350 degrees Fahrenheit.

In an embodiment, the heat exchanger can receive steam from a Fischer-Tropsch synthesis reactor for heating the initial nitrogen gas.

The present system further includes a combustion turbine engine, which can include a gas engine, a turboshaft engine, a radial gas turbine, or other similar combustion turbine engines, for producing a combustion turbine exhaust.

The combustion turbine exhaust can be recovered directly from the turbine or from a Heat Recovery Steam Generator (HRSG) downstream of the turbine. It is contemplated that any reduction of the heat recovered by a HRSG can be offset by the savings in fuel provided by using the combustion turbine exhaust to create a dry fuel feedstock in lieu of fueling an incinerator. The savings of low-sulfur fuel achieved by use of combustion turbine exhaust to dry lignite coal is approximately 901,591 Btu (LHV) per ton of lignite dried. The corresponding loss of recovered HRSG steam is approximately 658,531 Btu per ton of lignite, which is contemplated to have a power recovery rate of approximately 17,065 Btu per kWh. Thus, the loss of steam turbine driven power production is more than offset by the fuel savings.

An apparatus for forming a pulverized fuel, such as pulverized bituminous or lignite coal, receives the heated nitrogen gas and the combustion turbine exhaust, thereby forming a gas/particulate mixture of steam, nitrogen, and pulverized fuel. It is contemplated that the combustion turbine exhaust can raise the temperature of the heated nitrogen gas to at least 572 degrees Fahrenheit.

The apparatus can include a crusher/classifier for receiving, crushing, and classifying coal, such as a MPS vertical mill made by Gebrudder Pfeiffer AG (Gebr. Pfeiffer AG) of Germany or a vertical roller mill for coal with classifiers made by Alstrom of France. The apparatus can also include a biomass pulverizer for receiving and forming biomass particles. Combinations of coal crusher/classifiers and biomass pulverizers can be used when a fuel source containing both coal and biomass is pulverized.

Use of a pneumatic conveyance dryer or similar drying apparatus for drying biomass is also contemplated, for avoiding ignition or thermal degradation of biomass. Tempering of dryer inlet temperatures to avoid thermal degradation can be achieved by recycling a portion of the dryer vent gas to the dryer inlet.

A filter, which can include one or more bag filters, such as those made by U.S. Air Filtration, Incorporated of Temecula, Calif., having one or more flow insertion wands for pulsing the filter bags at periodic intervals, can receive the gas/particulate mixture, filtering the dried fuel feedstock from the steam and nitrogen mixture.

The present system can also include a blower, which can be a centrifugal blower or a squirrel caged blower, such as those available from Gardner Denver of Quincy, Ill., for applying a vacuum to the filter. In an embodiment, the blower can provide from about 0.005 bars of vacuum to about 0.1000 bars of vacuum on the filter.

The blower removes a stream from the steam and nitrogen mixture from the filter. The blower raises the pressure of the stream of steam and nitrogen, allowing a first portion to be discharged to the atmosphere and a second portion to be mixed with additional dry nitrogen gas. It is contemplated that the recycle stream and additional nitrogen gas can be mixed with combustion turbine exhaust and used in a continuous process, to dry the fuel feedstock. In an embodiment, the additional dry nitrogen gas can be from the same source as the initial nitrogen gas.

In an embodiment, a standby incinerator, such as one made by Mac, Incorporated of Glenburn, Ohio, can be in communication with the apparatus for forming pulverized fuel, and selectively activated to provide flue gas for mixing with the heated nitrogen gas, to control oxygen content within the conveying gasses, or combinations thereof. In an embodiment, the oxygen content of combustion turbine exhaust can be limited by combusting a fuel, such as a clean, low sulfur fuel, in the stream. The combustion depletes the oxygen content of the combustion turbine exhaust while simultaneously raising its temperature.

One or more fans can be used to facilitate the flow of air from the pulverizing apparatus. It is also contemplated that the system can include one or more tubes for mixing the portion of the steam and nitrogen mixture that is to be recycled with additional nitrogen prior to introducing the mixture to the heat exchanger.

The system can include a dry feedstock silo or other similar containing apparatus for receiving dried fuel feedstock from the filter. In an embodiment, the filter can also be a storage vessel for the dried fuel feedstock.

In an embodiment, the flow rates of the initial nitrogen gas, the heated nitrogen gas, the combustion turbine exhaust, the gas/particulate mixture, the stream of steam and nitrogen, the discharge stream, the recycle stream, or combinations thereof can range from about 80,000 cubic feet to about 300,000 cubic feet per ton of pulverized fuel.

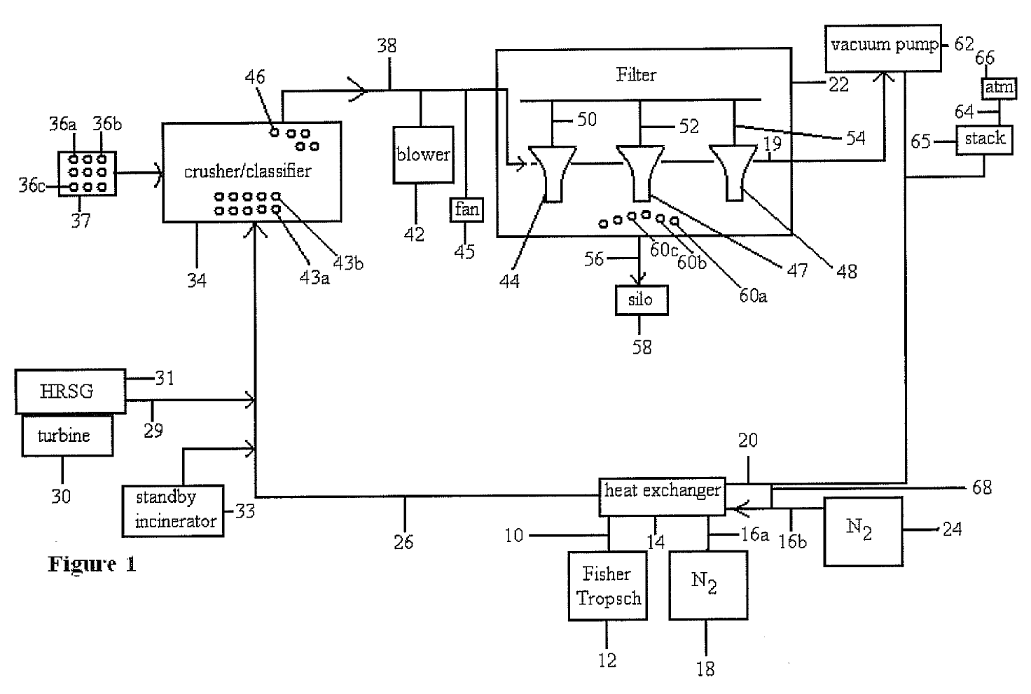

With reference to the figures, FIG. 1 depicts an embodiment of the present system, showing a schematic of a coal feedstock pretreatment system operated in conjunction with a Fischer-Tropsch reactor for preparing coal feedstocks. The same system can be used for preparing biomass feedstocks. However, the coal crusher classifier 34 would be replaced with a pulverizer for mashing, shredding, and cutting the biomass grasses, wood ships, or other matter. The coal crusher classifier and the pulverizer will be generally referred to herein as “apparatus for pulverizing a fuel source.”

FIG. 1 depicts steam 10 from a Fischer-Tropsch reactor 12, passed to a heat exchanger 14. A usable heat exchanger can be a shell and tube heat exchanger, a fin-fan heat exchanger, or a welded plate and frame heat exchanger.

The heat exchanger 14 additionally receives initial nitrogen gas 16a, from an initial nitrogen source 18, which can be an air separation facility or another type of nitrogen source. In an embodiment, it is contemplated that after start-up of the present system, the initial nitrogen gas can be replaced by recycle stream 20 of a steam and nitrogen mixture 19, recycled by the system. In this embodiment, the heat exchanger 14 can receive a mixture of additional nitrogen gas 16b from an additional nitrogen source 24 with recycle stream 20.

Additional nitrogen source 24 can be the same type of source as initial nitrogen source 18, or a different type of nitrogen source. In an embodiment, it is also contemplated that additional nitrogen source 24 and initial nitrogen source 18 can be the same nitrogen source, providing nitrogen gas both on start-up to steam 10 and during operation to recycle stream 20.

The initial nitrogen gas can be either generally pure or 100% dry nitrogen gas or a dry mixture of nitrogen with about 4 wt % to about 8 wt % oxygen gas based on the total content of the mixture.

The heat exchanger 14 uses the steam 10 from the Fischer-Tropsch reactor 12 to heat the initial nitrogen gas 16a to a temperature ranging from about 212 degrees Fahrenheit to about 350 degrees Fahrenheit.

After startup, the heat exchanger 14 can use the steam 10 from the Fisher-Tropsch reactor 12 to heat the recycle stream 20 with initial nitrogen gas 16a, additional nitrogen gas 16b or combinations thereof, forming heated nitrogen gas 26.

The heated nitrogen gas (26) is received by a coal crusher classifier (34), where heated nitrogen gas 26 can be heated by combustion turbine exhaust 29 conveyed into coal crusher classifier 34 from a combustion turbine 30. In an embodiment, a standby incinerator 33 can be used to provide flue gas for heating heated nitrogen gas 26.

The mixing of combustion turbine exhaust 29 with the heated nitrogen gas 26 in the coal crusher classifier 34 yields a gas mixture having a temperature of at least 572 degrees Fahrenheit. Combustion turbine 30 is shown having a Heat Recovery Steam Generator stack 31, which can be used to discharge HRSG exhaust to the atmosphere or to pass the combustion turbine exhaust 29 to the coal crusher classifier 34.

The coal crusher classifier 34 is contemplated to be a device that receives lumps of coal 36a, 36b and 36c from a coal receptacle 37. The lumps of coal 36a, 36b and 36c typically contain some water, causing the coal crusher classifier 34 to pulverize the lumps of coal 36a, 36b and 36c into wet coal dust. A usable crusher classifier can be a MPS vertical mill made by Gebrudder Pfeiffer AG (Gebr. Pfeiffer AG) of Germany. Vertical roller mills for coal with classifiers made by Alstrom of France are also contemplated herein. It is contemplated that any type of crusher or milling device with a classifier for coal can be used. Similar processing apparatuses for biomass can also be used.

The coal crusher classifier 34 receives the heated nitrogen gas 26 and the combustion turbine exhaust 29 and passes the gasses through the pulverized and classified wet coal. This activity vaporizes water from the wet coal and forms a mixture of nitrogen, steam, and pulverized fuel source, which FIG. 1 depicts as ground coal dust 46.

The combustion turbine 30 and heat exchanger 14 are maintained in communication with the coal crusher classifier 34 using tubing or similar connection means that can also be in communication with a blower 42 or fan 45, which draws the gasses through the coal crusher classifier 34 using the momentum of the hot gasses to convey ground coal dust 46 while permitting crushed larger particles of coal 43a and 43b to gather in the base of the coal crusher classifier 34 to be crushed further.

The heated nitrogen gas and ground coal dust mixture 38 can be passed to a filter 22. FIG. 1 depicts filter 22 as a vessel containing bag filters 44, 47 and 48. Each bag filter 44, 47 and 48 is shown having a flow insertion wand 50, 52 and 54 for pulsing each bag filter 44, 47 and 48, enabling the dried fuel feedstock to fall to the bottom of the filter 22 vessel.

While FIG. 1 depicts only three filter bags, a usable filter 22 is contemplated to hold from about 50 filtering bags to about 500 filtering bags, or more. A contemplated embodiment can include a filter having 100 filtering bags. It is contemplated that fewer bag filters can be used for smaller flow rate gasses with lower velocities, while a larger number of bag filters would be needed for higher velocities.

The filter 22 can use bag filters having a pore size ranging from about 5 microns to about 50 microns, such as those made by Gore Tex Company of Newark, Del. The bag filters 44, 47 and 48 enable the heated nitrogen gas and ground coal dust mixture 38 containing coal dust, steam, and nitrogen to flow into the bags, causing dried fuel feedstock to be collected on the outside of the bag filters 44, 47 and 48. The gas can then pass out of the filter 22 as clean nitrogen and steam without particles.

The flow insertion wands 50, 52 and 54 pulse the bag filters periodically, causing dried coal dust 60a, 60b and 60c on the exterior of the bag filters 44, 47 and 48 to fall to the bottom of the filter 22 for removal. It is contemplated that each bag filter can hold from about 10 liters to about 50 liters of gas, and each filter bag can have a shape of a wind sock. The filter 22 can have a filter housing made of metal, to prevent deformation in the presence of hot steam and hot gasses. The bag filter housing can be made from steel, stainless steel, or another metal alloy that can withstand the impact and temperature of the coal dust and steam without degrading.

Dried pulverized coal feedstock 56 is removed from the filter 22 using gravity and collected in a silo 58. Other types of containers besides silos can also be used to collect the dried pulverized coal feedstock 56.

A vacuum pump 62, can be used to apply a vacuum to the filter 22 such as a vacuum ranging from about 0.005 bars to about 0.100 bars, to evacuate the steam and nitrogen mixture 19 from the filter 22.

The steam and nitrogen mixture 19 can be separated into two streams, a discharge stream 64 comprising steam and nitrogen for discharge to the atmosphere 66 via a stack 65, and a recycle stream 20 of steam and nitrogen, which can be recycled back to the heat exchanger 14.

The recycle stream 20 can be mixed with additional dry nitrogen gas 16b from an additional nitrogen source 24 at the heat exchanger 14, or premixed in a vessel or tubing 68, forming a mixture of hot, moderately wet nitrogen with additional dry nitrogen gas, for flowing into the heat exchanger 14 to repeat the process.

The flow rate for the entire system is contemplated to range from about 80,000 cubic feet to about 300,000 cubic feet of gas mixture per ton of coal.

Alternative embodiments of the system contemplate using a blower instead of a vacuum pump 62, that can be a centrifugal blower or a squirrel caged blower adapted to provide between about 0.005 bars of vacuum to about 0.100 bars of vacuum on the filter 22. These types of blowers are available from Gardner Denver of Quincy, Ill.

The system contemplates producing a pulverized fuel source that contains from about 8% to about 10% absorbed water by weight. The pulverized fuel source can include combinations of wet pulverized coal and pulverized biomass, such as a mixture having from about 3% to about 10% biomass, or up to about 20% of pulverized biomass. In a contemplated embodiment, the pulverized fuel source can have about 95% particulate smaller than about 400 microns in diameter and about 50% particulate smaller than about 200 microns in diameter.

Pulverized biomass can include wood chips, switch grass, corn stover or corn stalks, bagasse from sugar cane, another leafy plant matter, or combinations of these items.

In another embodiment, the twice heated nitrogen gas can be passed through the pulverized fuel source at a flow rate ranging from about 80,000 cubic feet to about 300,000 cubic feet per ton of pulverized fuel source. It is also contemplated that the pulverized fuel source can be placed under a slight vacuum during heating.

An embodiment will now be described with reference to the following example.

### EXAMPLE 1

A slurry bubble column Fischer-Tropsch reactor having a mixture of cobalt catalyst and wax receives synthesis gas and exothermically provides heat. Water is boiled in coils in this column forming steam.

Steam from the Fischer-Tropsch reactor is transferred to a shell and tube heat exchanger, such as one made by Cust-O-Fab of Sand Springs, Okla.

Nitrogen gas and a recycled steam and nitrogen mixture are injected into the shell and tube heat exchanger and heated by the steam of the Fischer-Tropsch reactor, without mixing with the steam.

The heated mixture of nitrogen gas and the recycled steam and nitrogen mixture is then mixed with a combustion turbine exhaust produced from a combustion turbine, which further raises the temperature of the combined mixture of the nitrogen gas and recycled steam and nitrogen to about 572 degrees Fahrenheit, which forms a hot gas mixture.

The mixing of the heated nitrogen gas and the combustion turbine exhaust occurs upstream of a coal crusher/classifier.

The hot gas mixture blows through the crushed coal, upwards against gravity, entraining fine coal dust. The blowing gas permits larger coal particles to fall to the bottom of the crusher/classifier to be crushed into finer and smaller sizes. The process is continued until only fine coal dust is formed in the crusher/classifier. Then, the hot gas carries the dust, as a mixture, out of the crusher/classifier to a filter.

The combination of the fine coal dust and heated nitrogen gas, termed the “gas/particulate mixture”, which includes steam, nitrogen, and pulverized fuel, dries the pulverized fuel as the hot nitrogen gas passes over and through the particles and fine coal dust, drying the coal.

The heated gas, particulate, and steam mixture can be injected into the bag filter housing slowly and at a slight vacuum through the bag filters The residence time for the coal dust on the filters within the bag filter housing can be as short as 30 seconds. The nitrogen and steam is contemplated to pass through the filter bags. The bag filters in the vessel are pulsed to shake off the coal dust for about 1 second of every 30 seconds using at least one flow insertion wand for periodically pulsing each bag filter within the vessel.

The gas and steam mixture is removed from the bag filter housing using a gas blower which applies a small vacuum of about 0.1 bar to the filter. The gas blower acts like a vacuum to suction the gas. The blower increases the pressure of the nitrogen gas and steam mixture, permitting reuse of at least a portion of the gas and steam mixture while discharging of a portion.

The portion of the nitrogen gas and steam mixture to be reused is directed to the shell and tube heat exchanger, where it mixes with additional dry nitrogen gas to form, in the shell heat exchanger, a gas and steam heated mixture.

Dried pulverized coal can be continuously removed from the bottom of the bag filter housing, wherein the dried pulverized coal has a water content ranging from about 6% by weight to about 10% by weight of water.

This example enables fine coal feedstocks to be dried in a continuous manner and enables waste heat to be recycled and reused from the Fischer-Tropsch reactions, saving on the cost of gas and electricity, and conserving the use of fossil fuels for these reactions.

While these embodiments have been described with emphasis on the preferred embodiments, it should be understood that within the scope of the appended claims, the embodiments might be practiced other than as specifically described herein.

What is claimed is:

1. A system for drying fuel feedstocks, comprising:
a. a heat exchanger for receiving an initial nitrogen gas from a nitrogen source and heating the initial nitrogen gas to a temperature from about 212 degrees Fahrenheit to about 350 degrees Fahrenheit, forming a heated nitrogen gas;
b. a combustion turbine engine for producing a combustion turbine exhaust;
c. an apparatus for forming a pulverized fuel, wherein the apparatus is selected from the group consisting of: a crusher/classifier for receiving, crushing, and classifying coal, a biomass pulverizer for receiving biomass and forming biomass particles, and combinations thereof, wherein the apparatus for forming a pulverized fuel receives the combustion turbine exhaust from the combustion turbine engine and the heated nitrogen gas from the heat exchanger, forming a gas/particulate mixture comprising nitrogen, steam, and pulverized fuel in a ratio from 40:1 to 150:1 cubic feet of gas per pound of pulverized fuel;
d. a filter for receiving the gas/particulate mixture from the apparatus for forming a pulverized fuel and filtering the gas/particulate mixture, forming a steam and nitrogen mixture from the gas/particulate mixture and a dried fuel feedstock; and
e. a blower for applying a vacuum to the filter for separating the steam and nitrogen mixture into a discharge stream for discharge and a recycle stream for mixing with an additional dry nitrogen gas prior to mixing with combustion turbine exhaust in a continuous process.

2. The system of claim 1, wherein the heat exchanger is a shell and tube heat exchanger, a fin-fan heat exchanger, or a welded plate and frame heat exchanger.

3. The system of claim 1, wherein the nitrogen source is an air separation plant.

4. The system of claim 1, wherein the heated nitrogen gas has a flow rate ranging from about 80,000 cubic feat to about 300,000 cubic feet per ton of pulverized fuel source.

5. The system of claim 1, wherein the combustion turbine engine is a member of the group consisting of: a gas engine, a turboshaft engine, a radial gas turbine, and combinations thereof.

6. The system of claim 1, wherein the combustion turbine exhaust has a flow rate ranging from about 80,000 to about 300,000 cubic feet per ton of pulverized fuel source.

7. The system of claim 1, wherein the filter comprises a plurality of bag filters and at least one flow insertion wand for pulsing the filter bags at periodic intervals.

8. The system of claim 1, wherein the steam and nitrogen mixture has a flow rate ranging from about 80,000 to about 300,000 cubic feet per ton of pulverized fuel source.

9. The system of claim 1, further comprising an incinerator in communication with the apparatus for forming pulverized fuel, for providing heated flue gas for mixing with the heated nitrogen gas.

10. The system of claim 1, wherein the blower is a centrifugal blower or a squirrel caged blower adapted to provide between about 0.005 bar of vacuum to about 0.100 bar of vacuum on the filter.

11. The system of claim 1, further comprising a fan for facilitating the flow of steam and nitrogen from the apparatus for forming a pulverizing fuel.

12. The system of claim 1, further comprising a dry feedstock silo for receiving the dried fuel feedstock from the filter.

13. The system of claim 1, further comprising tubes for mixing the second portion of the steam and nitrogen mixture with the additional dry nitrogen gas prior to introduction of the steam and nitrogen mixture to the heat exchanger.

14. The system of claim 1, wherein the additional dry nitrogen gas and the initial nitrogen gas are supplied from the nitrogen source.

15. The system of claim 1, wherein the heat exchanger receives steam from a Fischer-Tropsch synthesis reactor for heating the initial nitrogen gas.

16. The system of claim 1, wherein the dry fuel feedstock comprises coal, biomass, or combinations thereof.
